(19) United States
(12) Patent Application Publication
(10) Pub. No.: US 2013/0216180 A1
(43) Pub. Date: Aug. 22, 2013

(54) OPTICAL INTERCONNECT FABRICS IMPLEMENTED WITH STAR COUPLERS

(71) Applicants: Michael Renne Ty Tan, Menlo Park, CA (US); Wayne V. Sorin, Mountain View, CA (US); Paul Kessler Rosenberg, Sunnyvale, CA (US); Sagi Varghese Mathai, Palo Alto, CA (US); Georgios Panotopoulos, Berkeley, CA (US)

(72) Inventors: Michael Renne Ty Tan, Menlo Park, CA (US); Wayne V. Sorin, Mountain View, CA (US); Paul Kessler Rosenberg, Sunnyvale, CA (US); Sagi Varghese Mathai, Palo Alto, CA (US); Georgios Panotopoulos, Berkeley, CA (US)

(21) Appl. No.: 13/881,134

(22) PCT Filed: Oct. 29, 2010
(86) PCT No.: PCT/US10/54774

§ 371 Date: Apr. 23, 2013

(51) Int. Cl. G02B 6/28; G02B 6/38

(52) U.S. Cl. CPC G02B 6/2817; G02B 6/3807
USPC 385/24; 385/46

(57) ABSTRACT

This disclosure is directed to scalable optical interconnect fabrics for distributing optical signals over a computer systems. In one aspect, an optical interconnect fabric includes a star coupler and a plurality of output optical fibers. Each output optical fiber is connected at a first end to the star coupler and is connected at a second end to a node of a plurality of nodes. The fabric also includes the input optical fiber connected at a first end to the star coupler and connected at a second end to a node of the plurality of nodes. The star coupler is to receive at least one optical signal via the input optical fiber, is to split each optical signal into a plurality of optical signals with approximately the same optical power, and is to output each optical signal into one of the output optical fibers.

### TECHNICAL FIELD

This disclosure relates to computer buses, and, in particular, to optical buses.

### BACKGROUND

Typical high performance rack mounted computer systems, such as a blade system, comprise a number of processor boards and memory boards that are in electronic communication over an electronic interconnect fabric. An ideal interconnect fabric allows processors and memory to scale independently in order to provide enough memory and processing speed to meet a seemingly ever increasing computational demand. However, electronic interconnect fabrics have a number of scaling disadvantages. They can be labor intensive to set up, and sending electronic signals over conventional electronic interconnects consumes large amounts of power. In addition, it is becoming increasingly difficult to scale the bandwidth of electronic interconnects, and the relative amount of time needed to send electronic signals over an electronic interconnect fabric is becoming too long to take full advantage of the high-speed performance offered by smaller and faster processors.

Manufacturers, designers, and users of large scale computer systems continue to seek improvements in interconnect fabrics.

### BRIEF DESCRIPTION OF THE DRAWINGS

FIGS. 1A-1B show isometric and side views, respectively, of an example star coupler.

FIG. 2A shows a side view of an example star coupler in operation.

FIG. 2B shows a side view of an example star coupler.

FIG. 2C shows a side view of an example star coupler.

FIG. 3 shows an example 1:6 beam splitter with partial mirrors that transmit light with approximately equal power.

FIG. 4 shows an example of a 1:N beam splitter.

FIG. 5 shows an example N-node system with each node connected to a separate optical interconnect fabric.

FIG. 6A shows an isometric view of an example blade system.

FIG. 6B shows a backplane of the example system shown in FIG. 6A.

FIG. 7 shows an isometric view of an example star coupler.

FIG. 8 shows an example N-node system with three nodes connected to an optical interconnect fabric.

FIG. 9 shows an example N-node system with the N nodes connected to an optical interconnect fabric.

FIG. 10 shows a backplane of an example blade system.

FIG. 11 shows a backplane of an example blade system.

### DETAILED DESCRIPTION

This disclosure is directed to scalable optical interconnect fabrics for computer systems. The optical interconnect fabrics allow processors and memory of a computer system to scale independently so that the computer system can be reconfigured to meet changing computational demands. In particular, optical interconnect fabrics allow large numbers of processors to be interconnected at low latency and memory can be scaled efficiently in terms of power consumption and size without adding significant latency. An optical interconnect fabric is implemented with a star coupler and multiple optical fibers that provide a relatively lower number of optical signal hop counts, lower power consumption, and can accommodate relatively higher data rates than conventional electronic interconnect fabrics.

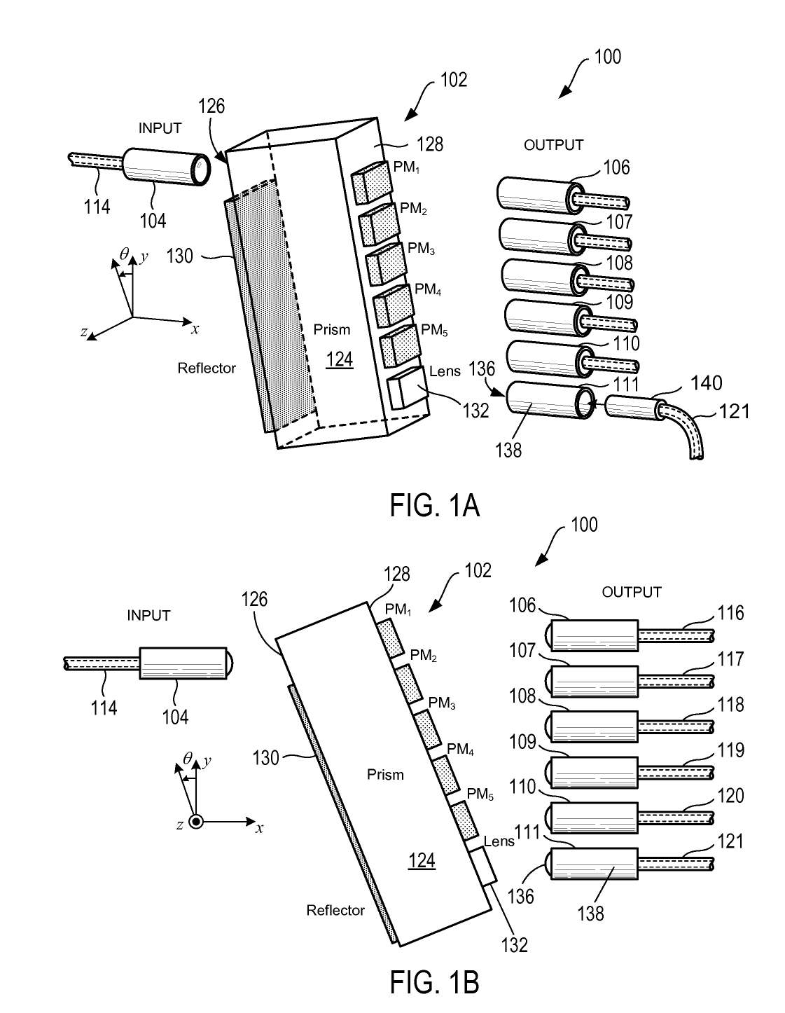

FIGS. 1A-1B show isometric and side views, respectively, of an example star coupler 100. The star coupler 100 includes a 1:6 beam splitter 102, a single input connector 104 and six output connectors 106-111. The input connector 104 is connected to a multimode optical fiber 114, and the six output connectors 106-111 are connected the multimode optical fibers 116-121, respectively. The splitter 102 includes a prism 124 with a first surface 126 and an opposing second surface 128. The first surface 126 is oriented approximately parallel to the second surface 128. The splitter 102 also includes a reflector 130 disposed on the first surface 126, five partial mirrors denoted by PM₁-PM₅ disposed on the second surface 128 opposite the reflector 130, and an antireflective surface 132 disposed on the second surface 128 opposite the reflector 130. The reflector 130 covers a portion of the first surface 126 leaving an uncovered portion 126 opposite the input connector 104 through which a beam of light output from the connector 104 can enter the prism 124. Output connectors 106-110 are aligned with PM₁-PM₅, and output connector 111 is aligned to antireflective surface 132. FIGS. 1A-1B include a Cartesian coordinate system with the splitter 102 and connectors 104, 106-111 arranged in the xy-plane and the splitter 102 tilted toward the input connector 104 through an angle θ about the z-axis.

Note that the reflector 130 can be single flat mirror or the reflector 130 can also be an array of curved mirrors. Each curved mirror re-collimates the reflected light to one of the partial mirrors.

The input and output connectors 104 and 106-111 can be female connectors that each includes a ferrule and a lens. For example, as shown in FIG. 1B, connector 111 includes a lens 136 mounted in a ferrule 138. The optical fibers 114 and 116-121 can include male connectors that are inserted into the connectors 104 and 106-111. For example, FIG. 1A shows the terminus end of the fiber 121, which includes a male connector 140 removed from ferrule 138.

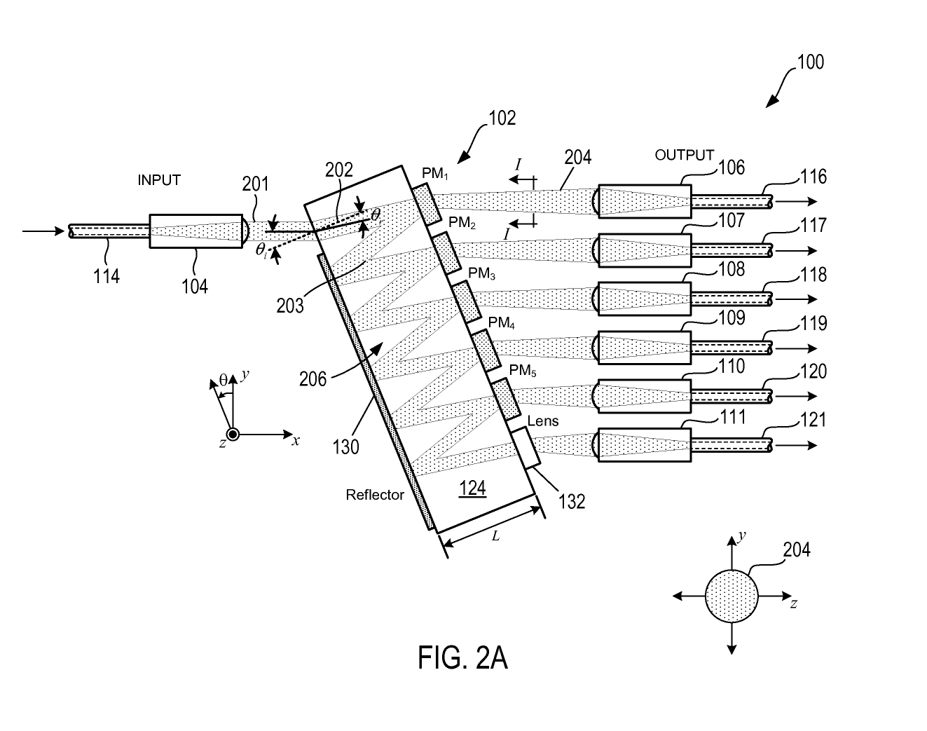

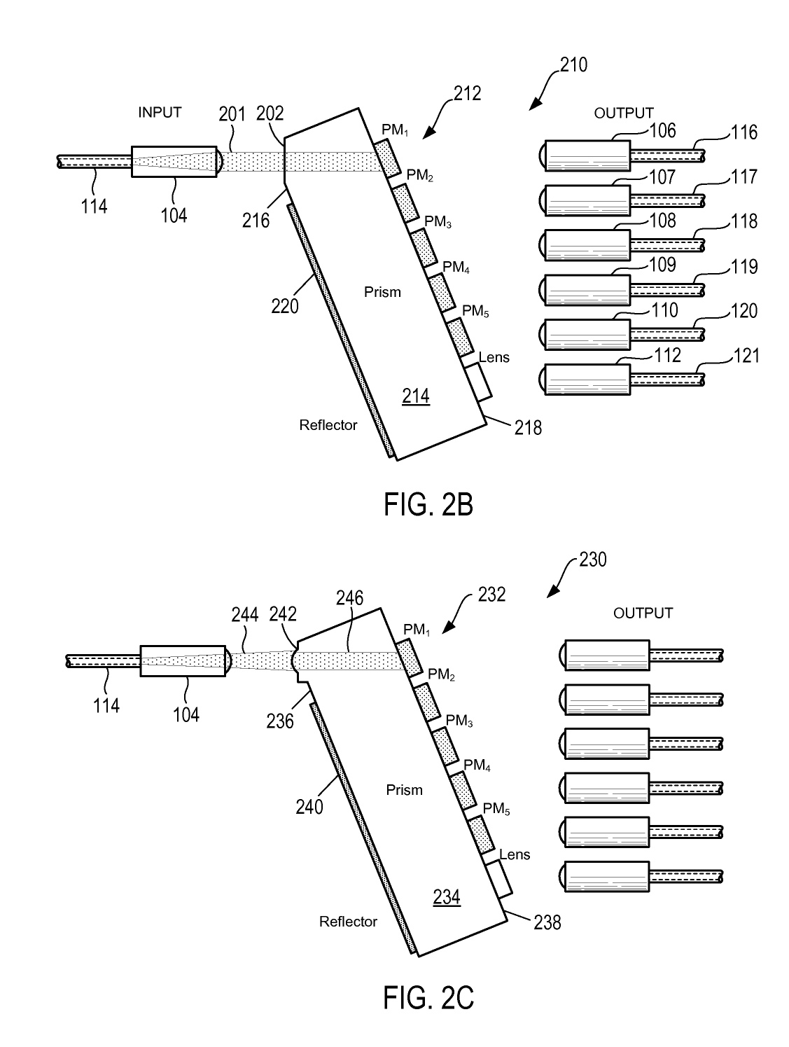

FIG. 2A shows a side view of the star coupler 100 in operation. Light enters the star coupler 100 via the optical fiber 114. The light can be composed of numerous wavelength division multiplexed (“WDM”) channels of electromagnetic radiation. A “channel” can be a frequency of electromagnetic radiation, or a narrow band of frequencies centered about a particular frequency, in the visible and/or non-visible portion of the electromagnetic spectrum. Alternatively, the light can be composed of numerous WDM optical signals. Each “optical signal” encodes data in the amplitude or phase or combination of amplitude and phase of a particular channel. The input connector 104 collimates the light into an input beam 201 that enters the prism 124 with an angle of incidence θᵢ to normal 202. The prism 124 can be composed of crown glass (i.e., refractive index n≈1.52) or another suitable refractive index material. Upon entering the prism 124, the beam 201 is refracted toward PM₁ with an angle of refraction θᵣ to the normal 202. The PM₁ splits the beam 201 into an internally reflected beam 203 and a transmitted output beam 204. The reflected beam 203 includes a first portion of the beam's 201 optical power, and the transmitted beam 204 includes a second portion of the beam's 201 optical power. As shown in FIG. 2A, the thickness L of the prism 124, angle of incident and regular spacing between partial mirrors PM₁-PM₅ are selected to form an internal zigzag beam 206 that bounces back and forth between the partial mirrors PM₁-PM₅ and the reflector 130 in a zigzag pattern. Each time the beam 206 strikes a partial mirror, a first portion of the beam 206 is reflected toward the reflector 130 and a second portion is transmitted to a corresponding output connector. As a result, the beam 206 is attenuated as it bounces back and forth between the reflector 130 and the partial mirrors. The lens 132 simply directs the remaining portion of the optical power in the beam 206 to the output connector 111.

As shown in FIG. 2A, the zigzag beam 206 remains collimated as the beam 206 is reflected back and forth between the partial mirrors PM₁-PM₅. The transmitted output beams passing through the partial mirrors PM₁-PM₅ toward the output connectors remain relatively collimated but maintain an approximately circular cross section. For example, FIG. 2A includes a circular cross section of the transmitted beam 204 along a line I-I. The output connectors 106-111 each receive a transmitted beam from a corresponding partial mirror and focus the beams into connected optical fibers.

In other example star couplers, the prism can be configured so that light input to the beam splitter is not refracted in the manner described above with reference to FIG. 2A. FIG. 2B shows a side view of an example star coupler 210. The star coupler 210 is similar to the star coupler 100. Like the star coupler 100, the star coupler 210 includes a 1:6 beam splitter 212 with a prism 214 having two opposing approximately parallel first and second surfaces 216 and 218 upon which a reflector 220 and partial mirrors are disposed, respectively. However, unlike the prism 124 of the star coupler 100, the prism 214 includes a third surface 222 adjacent to the first surface 216 and opposite the second surface 218. In the example of FIG. 2B, the third surface 222 is angled so that a beam of light 224 with approximately normal incidence on the third surface 222 enters the prism 214 and is not refracted in reaching the PM₁.

FIG. 2C shows a side view of an example star coupler 230. The star coupler 230 is similar to the star coupler 100. Like the star coupler 100, the star coupler 230 includes a 1:6 beam splitter 232 with a prism 234 having two opposing approximately parallel first and second surfaces 236 and 238 upon which a reflector 240 and partial mirrors are disposed, respectively. However, unlike the prism 124 of the star coupler 100, the prism 234 includes a convex lens 242 located adjacent to the first surface 236 and opposite the second surface 238. The convex lens 242 collimates an expanding beam 244 output from the connector 104 into a collimated beam 246 that strikes PM₁.

In other examples, the lens 242 can be implemented as a separate optical element, such as a plano-convex lens, with both splitters 102 and 212. The optical element can be oriented to focus the expanding beam 244 into a collimated beam, such as collimated beam 246, that enters the prism 124 of the splitter 102 or enters the prism 214 of the splitter 212.

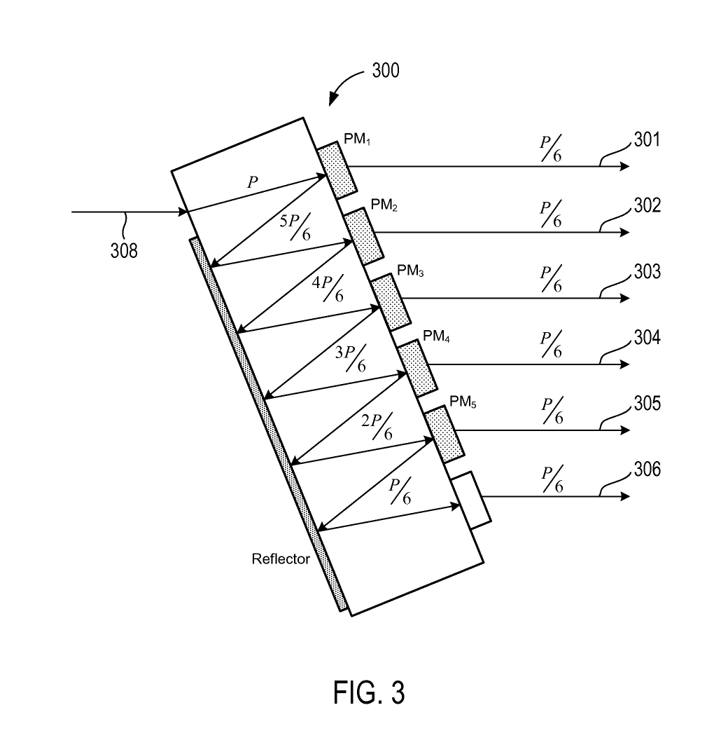

The partial mirrors PM₁-PM₅ can be subwavelength gratings, polka dot reflectors, dielectric mirrors, or partially silvered mirrors. The partial mirrors PM₁-PM₅ can be disposed on different substrates which are individually attached to the prism, or can be implemented on a single substrate, along with the antireflection surface. In certain star coupler examples, the partial mirrors PM₁-PM₅ transmit beams with approximately the same optical power. FIG. 3 shows an example 1:6 beam splitter 300 with partial mirrors PM₁-PM₅ configured so that the optical power of the transmitted output beams 301-306 are approximately ⅙ of the optical power of the input beam 308. For example, suppose that the optical power of the input beam 308 is represented by P. In order for the partial mirrors to transmit light with approximately the same optical power P/6, PM₁ is configured with a reflectance of about ⅚ (i.e., 5P/6) and a transmittance of about ⅙ (i.e., P/6). PM₂ is configured with a reflectance of about ⅘ (i.e., ⅘×5P/6) and a transmittance of about ⅕ (i.e., ⅕×5P/6). PM₃ is configured with a reflectance of about ¾ (i.e., ¾×4P/6) and a transmittance of about ¼ (i.e., ¼×4P/6). PM₄ is configured with a reflectance of about ⅔ (i.e., ⅔×3P/6) and a transmittance of about ⅓ (i.e., ⅓×3P/6). PM₅ is configured to operate as a 50:50 beam splitter with a reflectance of about ½ (i.e., ½×2P/6) and a transmittance of about ½ (i.e., ½×2P/6).

Star couplers are not limited to splitting a single beam into 6 separate beams. In other examples, star couplers can be configured to split a beam into as few as 2 beams and as many as 3, 4, 5, 7, or more beams. The maximum number of beams may be determined by the optical power of the input beam, the overall system loss, and the minimum sensitivity of the receivers used to detect the transmitted beams.

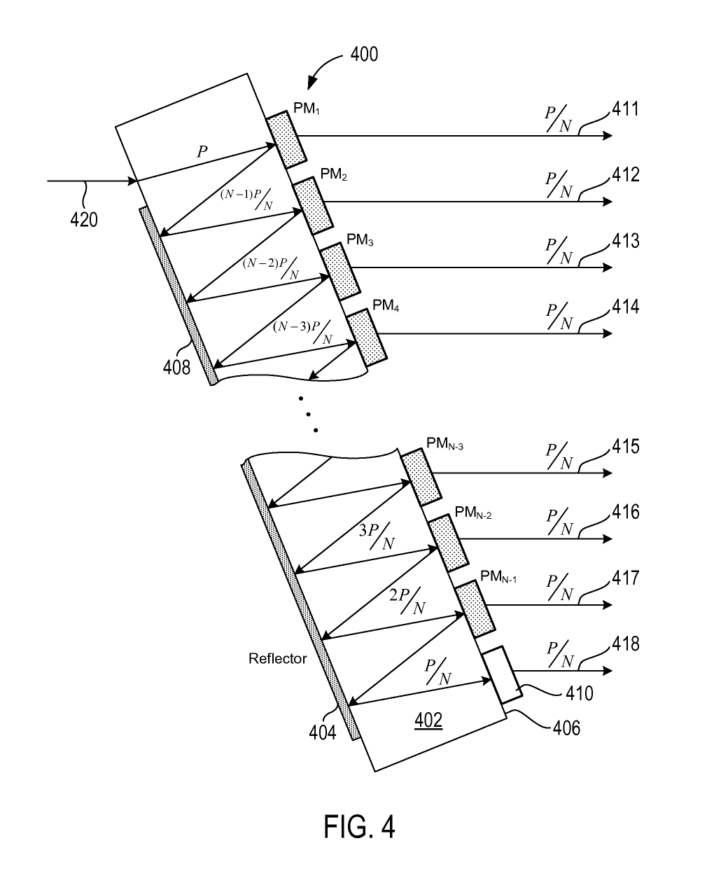

In general, the partial mirrors distributed along a surface of a beam splitter prism can be configured so that when a beam of optical power P enters the prism, each transmitted beam exits the splitter with an optical power of about P/N, where N is the number of transmitted beams. FIG. 4 shows an example 1:N beam splitter 400. The splitter 400 includes a prism 402 with a first surface 404 and a second surface 406, the first and second surfaces oriented approximately parallel to one another. The splitter 400 includes a reflector 408 disposed on the first surface 404 and includes partial mirrors PM₁-PM_{N} and an antireflection surface 410 disposed on the second surface 406. The partial mirrors are configured so that each transmitted output beam, represented by directional arrows 411-418, has approximately the same optical power of P/N, where P is the optical power of the input beam 420. In general, the partial mirrors, denoted by PMₘ, have a transmittance given by:

$${T}_{m} \approx \frac{1}{( N - m + 1 )}$$

and have a reflectance given by:

$${R}_{m} \approx \frac{( N - m )}{( N - m + 1 )}$$

where m is an integer ranging from 1 to N. Thus, a partial mirror PMₘ receives a beam of light with optical power P, reflects a beam of light to the reflector 408 with optical power PRₘ and transmits a beam of light with optical power PTₘ, where P=PRₘ+PTₘ+Lₘ with Lₘ representing the optical power loss due to absorption, scattering, or misalignment.

Note that in alternative beam splitter implementations, the prism and reflector can be configured with curved surfaces corresponding to the number of partial mirrors and the antireflection surface. The curved surfaces and curved reflectors internally re-collimate each beam of light reflected to the partial mirrors and the antireflection surface.

The beam splitters and connectors of a star coupler are mounted in an enclosure (not shown) that secures the splitter and connector positions, maintains a fixed separation between each connector and the splitter, and secures the splitter orientation. The enclosure enables the fibers to be selectively removed and inserted without disturbing the positions of the splitter and other fibers already inserted. For example, the number of devices that can be optically connected to the star coupler 100 to receive one of the six optical signals or unmodulated channels output through output connectors 106-111 ranges from 1 to 6. In other words, the star coupler 100 enables the number of devices optically connected to receive optical signals or channels to be selectively scaled up or down by simply connecting or disconnecting a device's optical fiber.

A 1:N star coupler can be implemented in an optical interconnect fabric that enables a node in a system of nodes to broadcast optical signals to the other nodes. A node can be any combination of processors, memory, memory controllers, electrical-to-optical engines, optical-to-electrical engines, clusters of multi-core processing units, a circuit board, external network connections, or any other data processing, storing, or transmitting device.

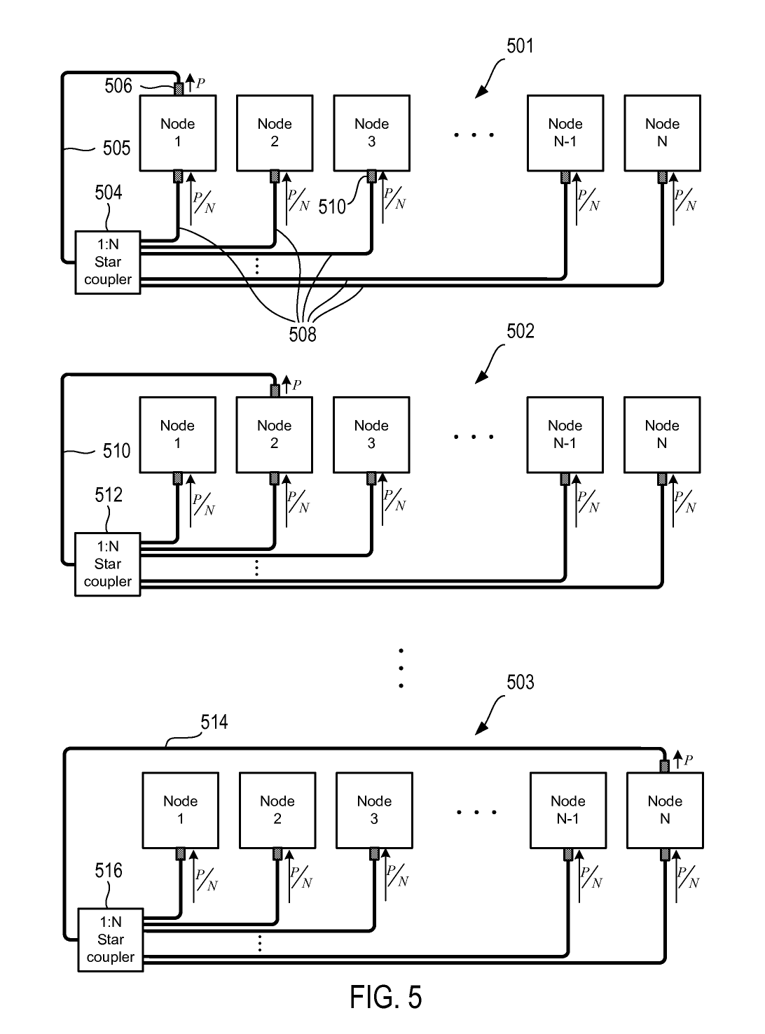

FIG. 5 shows an example N-node system where each node is connected to an optical interconnect fabric. The nodes are labeled 1-N. For the sake of convenience, FIG. 5 shows only three of N optical interconnect fabrics 501-503. Optical interconnect fabric 501 includes a 1:N star coupler 504, a single multimode input optical fiber 505 connected at a first end to the star coupler 502 and connected at a second end to an electrical-to-optical (“EO”) converter 506 at node 1, and N multimode output optical fibers 508, each of which is connected at a first end to the star coupler 502 and connected at a second end to an optical-to-electrical (“OE”) converter at one of the N nodes, such as OE converter 510. Fiber 505 is used to send optical signals from node 1 and is connected to an input connector (not shown) of the star coupler 502, such as input connector 104 of the 1:6 star coupler 100 shown in FIG. 1, and each of the N optical fibers 508 is connected to an output connector (not shown) of the star coupler 502, such as output connectors 106-111 of the 1:6 star coupler 100. The fibers 508 receive the optical signals output from the star coupler 502. Fabric 501 enables node 1 to broadcast optical signals to nodes 1-N as follows. Node 1 generates data in the form of an electronic signal that is converted into an optical signal with optical power P at EO converter 506. The optical signal is input to fiber 505 and transmitted to star coupler 502. Star coupler 502 includes a 1:N beam splitter, such as the splitter 400, that splits the optical signal into N separate optical signals. Each of optical signals encodes the same data and exits the 1:N beam splitter with the same optical power P/N, as described above with reference to FIG. 4. Each of the N optical signals enters one of the optical fibers 508 via an output connector, as described above with reference to FIG. 3, and is transmitted to one of the N nodes, where a OE converter converts the optical signal into an electronic signal that can be processed at the node.

Optical interconnect fabric 502 is similar to fabric 501, except fabric 502 includes a multimode optical fiber 510 that connects node 2 to a 1:N star coupler 512. Fabric 502 enables node 2 to broadcast optical signals to nodes 1-N in the same manner node 1 broadcast optical signals to nodes 1-N over fabric 501. Optical interconnect fabric 503 is also similar to fabric 501, except fabric 503 includes a multimode optical fiber 514 that connects node N to a 1:N star coupler 516. Fabric 503 enables node N to broadcast optical signals to nodes 1-N in the same manner node 1 broadcast optical signals to nodes 1-N over fabric 501.

Note that the optical interconnect fabric examples described above, and below, direct the optical signals generated by a node back to the originating node. This is done for two primary reasons: 1) It ensures that the star coupler is operating correctly. 2) By diverting optical signals back to a node from which they originated, the node is able to perform diagnostic tests on the optical signals, such as testing optical signal integrity.

The N optical interconnect fabrics can be implemented in a backplane of a blade system, enabling each blade in the blade system to broadcast optical signals to other blades in the system. A blade system is a server chassis housing multiple, modular electronic circuit boards known as server blades or blades. The server chassis or blade enclosure, which can hold multiple blades, provides services such as power, cooling, networking, various interconnects and blade management. Each blade can be composed of at least one processor, memory, integrated network controllers, and other input/output ports, and each blade may also be configured with local drives and can connect to a storage pool facilitated by a network-attached storage, Fiber Channel, or iSCSI storage-area network.

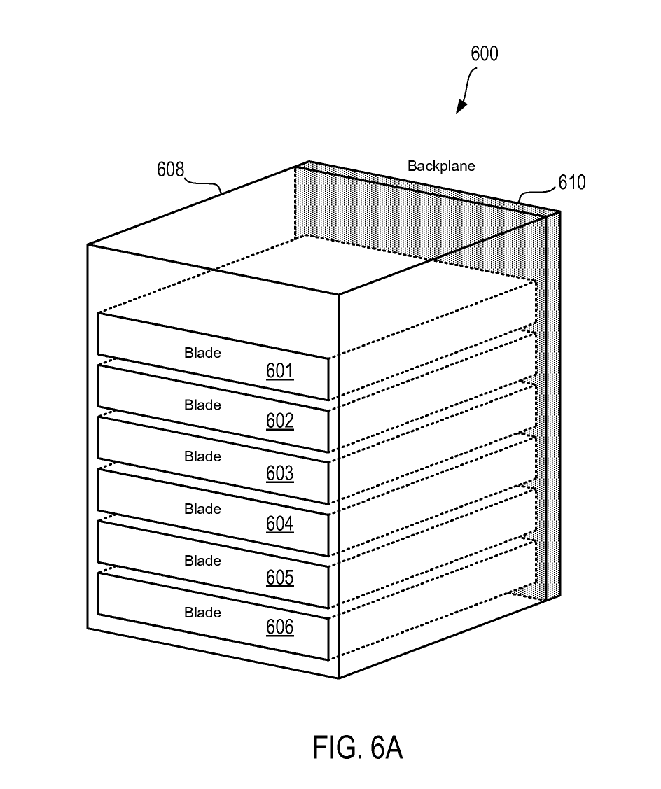

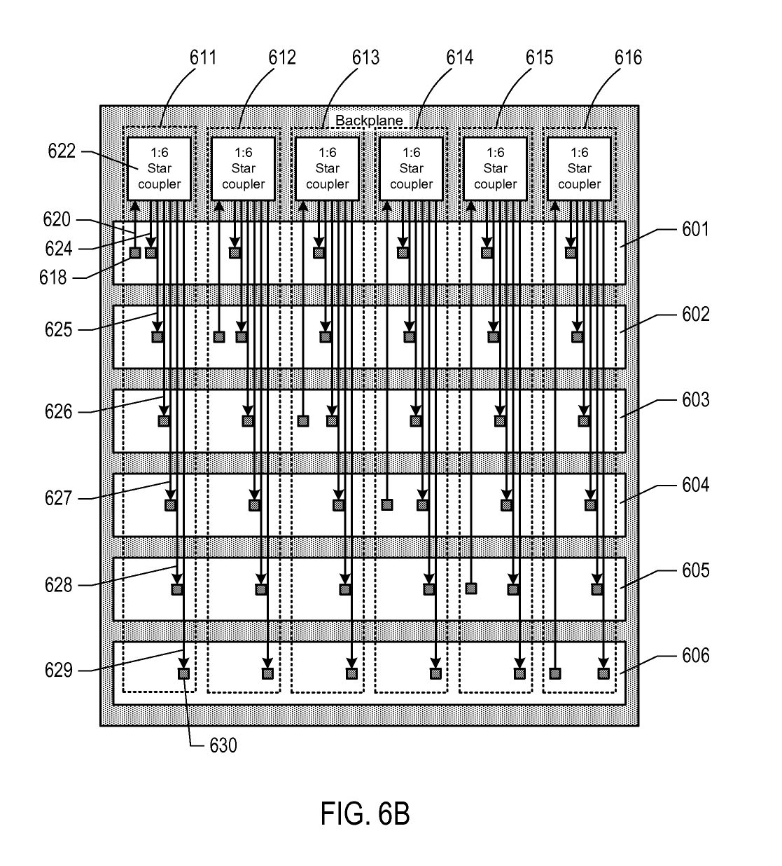

FIG. 6A shows an isometric view of an example blade system 600 composed of six blades 601-606 mounted in a blade enclosure or chassis 608. Each blade is connected to a backplane 610 that provides input/output optical connectivity between the blades. FIG. 6B shows a backplane of the example system 600. In the example of FIG. 6B, the backplane 610 includes six separate optical interconnect fabrics identified by dashed-line enclosures 611-616. Directional arrows are used to represent optical fibers and the direction optical signals traverse the optical fibers. Each optical interconnect fabric includes a 1:6 star coupler. For example, optical interconnect fabric 611 enables blade 601 to broadcast optical signals to blades 601-606. Electronic signals generated by blade 1 are converted at EO converter 618 into optical signals that traverse fiber 620 to star coupler 622. The star coupler 620 can be configured to operate in the same manner as the star couplers 100, 210, and 230 described above. The optical signals are collimated and split into six separate optical signals. The six optical signals encode the same data have with approximately the same optical power, and each optical signal enters one of the six separate multimode fibers 624-629. The optical signals are each converted into electronic signals at a corresponding OE converter. For example, OE converter 630 converts optical signals transmitted on fiber 629 into electronic signals that can be processed by blade 606. Multibus fabrics 612-616 are each operated in the same manner to broadcast optical signals generated by blades 602-606, respectively.

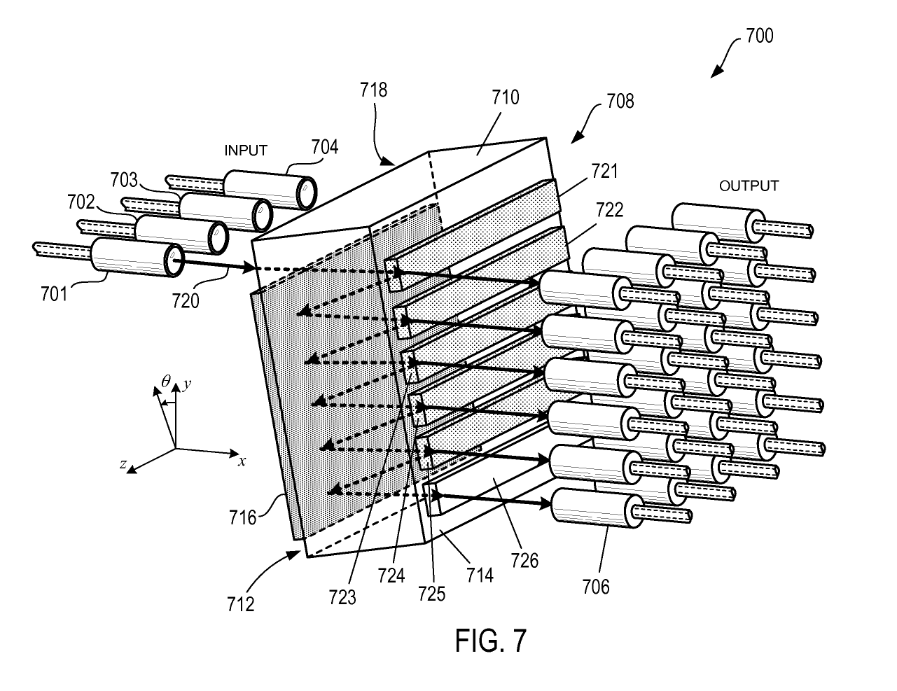

Star couplers are not limited to receiving light at a single input and splitting the light into N outputs. Star couplers can be configured to receive light in M separate inputs and split the light received at each input into N outputs and are referred to an M:M×N star couplers. FIG. 7 shows an isometric view of an example star coupler 700. The star coupler 700 includes a one-dimensional array of four input connectors 701-704 (i.e., M=4) and a two-dimensional array of 24 output connectors (i.e., N=6), such as output connector 706. The four input connectors 701-704 can be four separate connectors or a ribbon fiber connector. Star coupler 700 also includes a 4:4×6 beam splitter 708. Splitter 708 includes a prism 710 with opposing, approximately parallel first and second surfaces 712 and 714. As shown in the example of FIG. 7, a reflector 716 is disposed on a portion of the first surface 712 leaving an uncovered portion 718. The splitter 708 also includes five partial mirrors 721-725 that extend in the z-direction and an antireflection coated strip 726 disposed on the second surface 714. In the example of FIG. 7, the partial mirrors are configured to reflect and transmit light in the same manner as the partial mirrors PM₁-PM₅ described above with reference to FIG. 2. The partial mirrors can be disposed on different substrates which are individually attached to the prism 710, or the partial mirrors can be implemented on a single substrate along with the antireflection surface.

Note that the reflector 716 can be single flat mirror or the reflector 716 can also be an array of curved mirrors. Each curved mirror re-collimates the reflected light to one of the partial mirrors.

An input connector, column of partial mirrors and antireflection surface, and a column of output connectors split a beam of light in the same manner the star couplers described above with reference to FIGS. 1-3 split a beam of light. For example, as shown in FIG. 7, input connector 701 directs a beam of light 720 into the splitter 708 through uncovered portion 718 of the prism 710. The beam bounces back and forth between a column of partial mirrors 722 and the reflector 716 as described above with reference to FIG. 3. Beams of light are output from the partial mirrors and antireflection surface in the column 722 with approximately the same optical power. As shown in FIG. 7, the input connectors 701-704 direct input beams of light in parallel to the prism 710 and the partial mirrors and antireflection surface are aligned with the output connectors so that beams output from the partial mirrors are approximately parallel and each beam is directed into a corresponding output connector. The input and output beams of light are transmitted in the same direction. The input and output connectors can be female connectors that each includes a ferrule and a lens, as described above with reference to FIG. 1. The optical fibers can also include male connectors that are inserted into the female connectors of the star coupler.

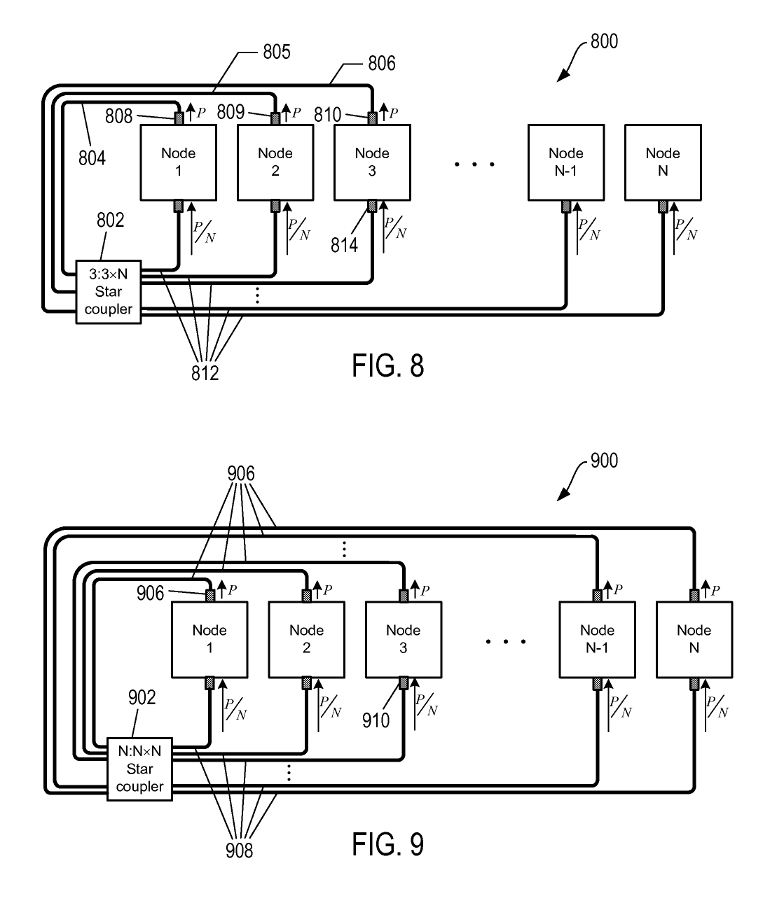

An M:M×N star coupler can be implemented in an optical interconnect fabric that enables a node in a system of nodes to broadcast optical signals to the other nodes. FIG. 8 shows an example N-node system where three nodes are connected to an optical interconnect fabric 800. The fabric 800 includes a 3:3×N star coupler 802, three multimode input optical fibers 804-806, each of which is connected at a first end to the star coupler 802 and connected at a second end to one of three EO converters 808-810. The fabric 800 also includes N multimode output optical fibers 812, each of which is connected at a first end to the star coupler 802 and at a second end to an OE converter at one of the N nodes, such as OE converter 814. Fibers 804-806 are connected to input connectors (not shown) of the star coupler 802, and each of the N optical fibers 812 is connected to an output connector (not shown) of the star coupler 802. Fabric 800 enables each of the nodes 1-3 to broadcast optical signals to nodes 1-N, as described above with reference to FIG. 5.

FIG. 9 shows an example N-node system where the N nodes are connected to an optical interconnect fabric 900. The fabric 900 includes an N:N×N star coupler 902, N multimode input optical fibers 904, each of which is connected at a first end to the star coupler 902 and connected at a second end to one of the N EO converters, such as EO converter 906. The fabric 900 also includes N multimode output optical fibers 908, each of which is connected at a first end to the star coupler 902 and at a second end to an OE converter at one of the N nodes, such as OE converter 910. The fabric 900 enables each of the N nodes to broadcast optical signals to nodes 1-N, as described above with reference to FIG. 5.

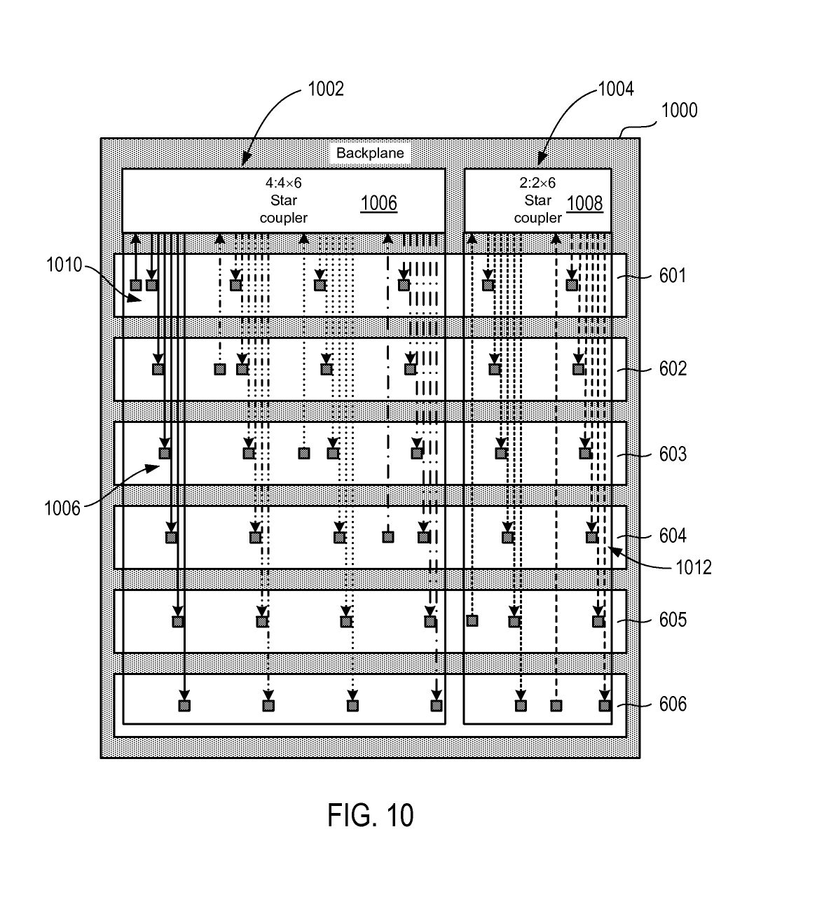

The M:M×N star couplers can be implemented in a backplane of a blade system. FIG. 10 shows an example backplane 1000 of the example blade system 600. The backplane 100 includes two separate optical interconnect fabrics 1002 and 1004. Optical interconnect fabric 1002 includes a 4:4×6 star coupler 1006, and optical interconnect fabric 1004 includes a 2:2×6 star coupler 1008. Optical interconnect fabric 1002 enables blades 601-604 to broadcast optical signals to blades 601-606, and optical interconnect fabric 1004 enables blades 605 and 606 to broadcast optical signals to blades 601-606. Different line patterns are used to represent the sets of optical fibers used by a blade to broadcast optical signals. For example, solid line directional arrows 1010 represent the optical fibers blade 601 uses to broadcast optical signals to blades 601-606, and dashed line directional arrows 1012 represent the optical fibers blade 606 uses to broadcast optical signals to the blades 601-606. Each blade broadcasts optical signals in the manner described above with reference to FIG. 6.

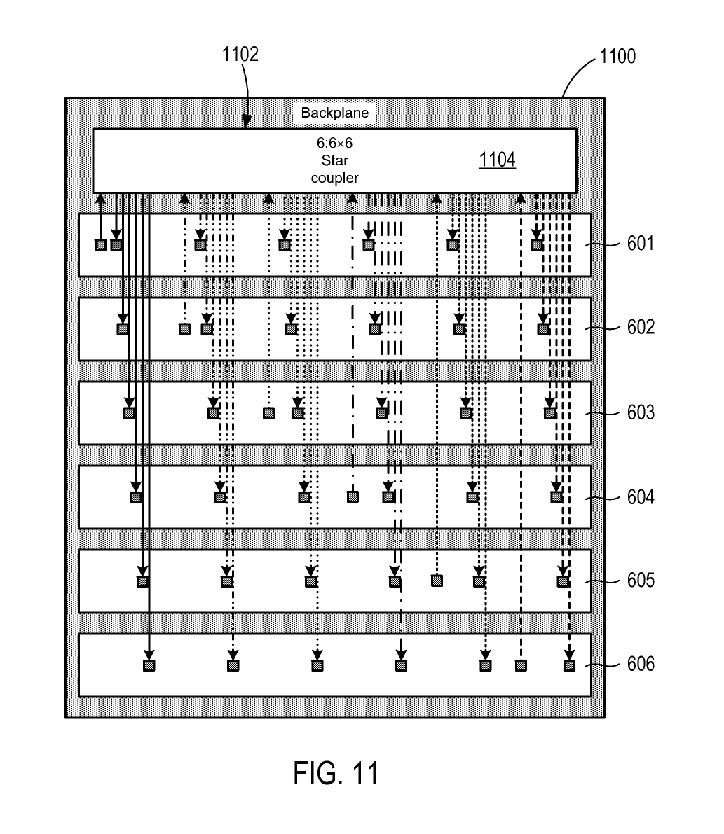

FIG. 11 shows an example backplane 1100 of the example blade system 600. The backplane 1100 includes a single optical interconnect fabric 1102. Optical interconnect fabric 1102 includes a 6:6×6 star coupler 1104, which enables blades 601-606 to broadcast optical signals to blades 601-606. Each blade broadcasts optical signals over a corresponding set of optical fibers in the manner described above with reference to FIG. 6.

The foregoing description, for purposes of explanation, used specific nomenclature to provide a thorough understanding of the disclosure. However, it will be apparent to one skilled in the art that the specific details are not required in order to practice the systems and methods described herein. The foregoing descriptions of specific embodiments are presented for purposes of illustration and description. They are not intended to be exhaustive of or to limit this disclosure to the precise forms described. Obviously, many modifications and variations are possible in view of the above teachings. The embodiments are shown and described in order to best explain the principles of this disclosure and practical applications, to thereby enable others skilled in the art to best utilize this disclosure and various embodiments with various modifications as are suited to the particular use contemplated. It is intended that the scope of this disclosure be defined by the following claims and their equivalents:

1. An optical coupler comprising:
a star coupler;
an input connector to direct an input beam of light into the star coupler; and
a plurality of output connectors, wherein the star coupler split the input beam into a plurality of approximately parallel output beams that exit the star coupler with approximately the same optical power, in which each output beam is to enter one of the output connectors.

2. The coupler of claim 1, wherein the star coupler further comprises:
a prism having a first surface and a second surface located opposite the first surface;
a reflector disposed on a portion of the first surface;
a plurality of partial mirrors disposed on the second surface; and
an antireflection surface disposed on the second surface, wherein each input beam is to enter the star coupler through the first surface and bounce back and forth to form a zigzag beam between the reflector and the partial mirrors such that each output beam is to be a portion of the zigzag beam transmitted through one of the partial mirrors or the antireflection surface.

3. The coupler of claim 2, wherein the first surface is planar and the reflector is a planar mirror.

4. The coupler of claim 2, wherein the first surface includes a plurality of curves and the reflectors are curved to re-collimate beams of light reflected to the partial mirrors and the antireflection surface.

5. The coupler of claim 1, wherein the input connector further comprises a lens mounted in a ferrule that receives an optical fiber, such that light is to enter the input connector through the optical fiber and is collimated by the lens into an input beam.

6. The coupler of claim 1, wherein each output connector further comprises a lens mounted in a ferrule that receives an optical fiber, such that an output beam is to enter the output connector through the lens and is to be focused into the optical fiber.

7. An optical interconnect fabric comprising:
a star coupler;
a plurality of output optical fibers, each output optical fiber connected at a first end to the star coupler and connected at a second end to a node of a plurality of nodes; and
an input optical fiber connected at a first end to the star coupler and connected at a second end a node of the plurality of nodes, wherein the star coupler is to receive at least one optical signal via the input optical fiber, is to split each optical signal into a plurality of optical signals with approximately the same optical power, and is to output each optical signal into one of the output optical fibers.

8. The fabric of claim 7, wherein each receiving optical fiber connected at the second end to the node further comprises the output optical fiber connected at the second end to an optical-to-electrical converter to be operated by the node.

9. The fabric of claim 7, wherein the at least one input optical fiber connected at the second end to the node further comprises the input optical fiber connected at the second end to an electrical-to-optical converter to be operated by the node.

10. The fabric of claim 7, wherein the optical signals are approximately parallel upon input to the star coupler.

11. The fabric of claim 7, wherein the plurality of optical signals are to be output from the star coupler in the same direction as optical signal enters the star coupler.

12. The fabric of claim 7, wherein the star coupler further comprises
a star coupler;
an input connector, each input connector connected to the first end of the input optical fiber and to direct the optical signal carried by the input optical fiber into the star coupler; and
a plurality of output connectors, each output connector connected to the first end of the output optical fiber, wherein the star coupler is to split the optical signal into the plurality of optical signals with approximately the same optical power, each optical signal is to enter one of the output connectors.

13. The fabric of claim 12, wherein the star coupler further comprises:
a prism having a first surface and a second surface located opposite the first surface;
a reflector disposed on a portion of the first surface;
a plurality of partial mirrors disposed on the second surface; and
an antireflection surface disposed on the second surface, wherein each optical signal is to enter the star coupler through the first surface and is to bounce back and forth to form a zigzag beam between the reflector and the partial mirrors such that each optical signal output from the star coupler is to be a portion of the zigzag beam transmitted through one of the partial mirrors or the antireflection surface.

14. The fabric of claim 12, wherein the input connector further comprises a lens mounted in a ferrule that receives one of the at least one input optical fiber, such that an optical signal is to enter the input connector through the optical fiber and is to be collimated by the lens.

15. The fabric of claim 12, wherein each output connector further comprises a lens mounted in a ferrule that receives one of the plurality of output optical fiber, such that an optical signal is to enter the output connector through the lens and is to be focused into the optical fiber core.
